(19) United States
(12) Patent Application Publication
(10) Pub. No.: US 2011/0069227 A1
(43) Pub. Date: Mar. 24, 2011

(54) IMAGE PROCESSING APPARATUS AND CONTROL METHOD THEREOF

(75) Inventor: Ai Kawai, Kawasaki-shi (JP)

(73) Assignee: CANON KABUSHIKI KAISHA, Tokyo (JP)

(21) Appl. No.: 12/883,070

(22) Filed: Sep. 15, 2010

(30) Foreign Application Priority Data
Sep. 24, 2009 (JP) 2009-219221

(51) Int. Cl. H04N 7/01

(52) U.S. Cl. 348/452; 348/441; 348/E07.003

(57) ABSTRACT

An apparatus is provided for generating high-frequency emphasized image data emphasizing a high-frequency component and low-frequency interpolated image data using motion compensation, from image data input for each frame, and outputting the high-frequency emphasized image data and the low-frequency interpolated image data as sub-frames. The apparatus includes a calculation unit configured to calculate an evaluation value of a motion vector detected during the motion compensation, and a control unit configured to control, based on the calculated evaluation value, luminance of the low-frequency interpolated image data to be lowered relative to the high-frequency emphasized image data.

### BACKGROUND OF THE INVENTION

1. Field of the Invention

The present invention relates to an image conversion technology for converting a frame rate of image data into a higher rate.

2. Description of the Related Art

Conventionally, as a technology for suppressing a motion blur or a flicker generated during displaying of a video by a display apparatus, for example, Japanese Patent Application Laid-Open No. 2009-042482 and Japanese Patent Application Laid-Open No. 2009-038620 discuss video display methods that use a frequency separation method of generating sub-frames having different frequency components from image data, and motion compensation.

Such a video display method generates, from input image data, high-frequency emphasized image data emphasizing a high-frequency component and low-frequency interpolated image data including a low-frequency component and acquired by performing motion compensation to suppress a high-frequency component, and alternately displays the image data. This technology enables suppression of flickers and reduction of motion blurs.

However, in the video display method discussed in Japanese Patent Application Laid-Open No. 2009-042482, the motion compensation may result in erroneous detection of a motion vector. In this case, the erroneously detected motion vector generates low-frequency interpolated image data that does not reflect motion of an image, causing a video failure to be visible.

### SUMMARY OF THE INVENTION

According to an aspect of the present invention, there is provided an apparatus for generating high-frequency emphasized image data emphasizing a high-frequency component and low-frequency interpolated image data using motion compensation from image data input for each frame, and outputting the high-frequency emphasized image data and the low-frequency interpolated image data as sub-frames. The apparatus includes a calculation unit configured to calculate an evaluation value of a motion vector detected during the motion compensation, and a control unit configured to control, based on the calculated evaluation value, luminance of the low-frequency interpolated image data to be lowered relatively to the high-frequency emphasized image data.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a main portion of an image processing apparatus.

FIG. 2 is a flowchart illustrating processing in the image processing apparatus.

FIG. 3 is a flowchart illustrating processing of a motion compensation unit in detail.

FIG. 4 illustrates a relationship between an evaluation value T_{ME} and a set luminance r_{Sub2}.

FIG. 5 is a block diagram illustrating a configuration of a main portion of an image processing apparatus.

FIG. 6 is a flowchart illustrating processing in the image processing apparatus.

FIG. 7 illustrates a relationship between a luminance difference value D and a set luminance value r_{Sub2}.

FIG. 8 is a block diagram illustrating a configuration of a main portion of an image processing apparatus.

FIG. 9 is a flowchart illustrating processing in the image processing apparatus.

FIG. 10 is a block diagram illustrating a hardware configuration example of a computer applicable to the image processing apparatus of each of the exemplary embodiments of the present invention.

FIG. 11A illustrates an output and a visible image thereof when a motion vector is erroneously detected (there is no luminance control).

FIG. 11B illustrates an output and a visible image thereof when a motion vector is erroneously detected (there is luminance control).

FIG. 12 illustrates an output and a visible image thereof when a motion vector is erroneously detected at a low-contrast edge.

FIG. 13 is a block diagram illustrating a different configuration of a luminance control unit.

### DESCRIPTION OF THE EMBODIMENTS

Various exemplary embodiments, features, and aspects of the invention will be described in detail below with reference to the drawings. Configurations described in the exemplary embodiments are only examples, and the illustrated configurations are in no way limitative of the present invention.

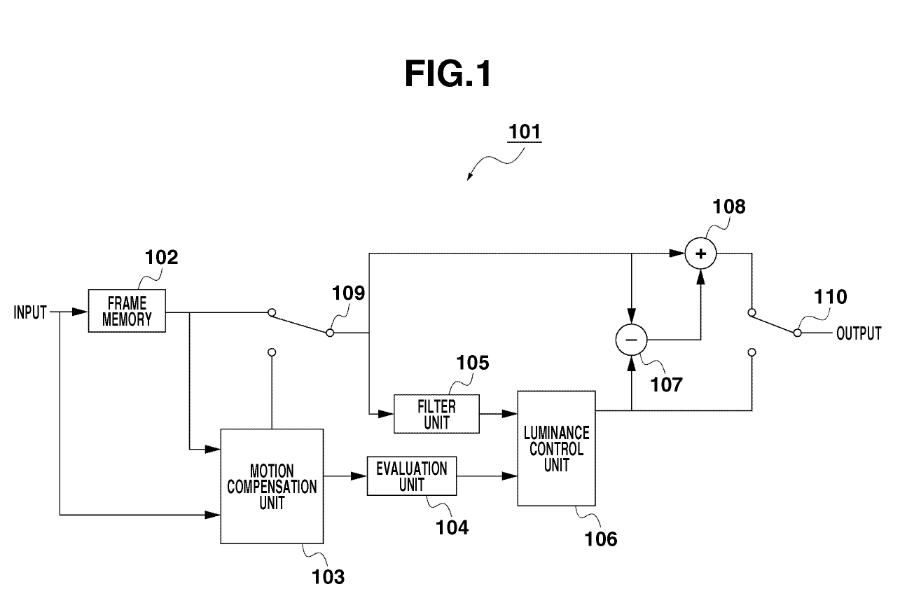

FIG. 1 is a block diagram illustrating a configuration of a main portion of an image processing apparatus 101 according to a first exemplary embodiment.

A frame memory 102 stores input image data by at least one frame so that a motion compensation unit 103 described below can detect a motion vector among a plurality of frames. The first exemplary embodiment shows an example of detecting a motion vector from two continuous frames. However, the motion compensation unit 103 may also detect a motion vector from a plurality of frames. The motion compensation unit 103 detects a motion vector based on input image data and past image data stored in the frame memory 102 (in the first exemplary embodiment, image data of a last frame of the input image data). The motion compensation unit 103 compensates for motion to generate interpolated image data in which image motion between frames has temporally been interpolated.

An evaluation unit 104 estimates reliability of the motion vector detected by the motion compensation unit 103 to output an evaluation value to a luminance control unit 106. A filter unit 105 suppresses high-frequency components of the input image data and the interpolated image data. In the first exemplary embodiment, the filter unit 105 outputs, by using a low-pass filter (LPF), a low-frequency image data in which the high-frequency component of the input image data has been suppressed and low-frequency interpolated image data in which the high-frequency component of the interpolated image data has been suppressed. The luminance control unit 106 controls luminances of the low-frequency image data and the low-frequency interpolated image data in which high-frequency components have been suppressed by the filter unit 105 based on the evaluation value output from the evaluation unit 104.

A subtracter 107 calculates a difference between the input image data and the low-frequency image data in which luminance has been modulated by the luminance control unit 106. This processing enables calculation of a high-frequency component of the input image data. An adder 108 adds the input image data and the high-frequency component calculated by the subtracter 107 together to generate the image data emphasizing the high-frequency component. The subtracter 107 calculates a difference between the interpolated image data and the low-frequency interpolated image data in which luminance has been modulated by the luminance control unit 106. This processing enables calculation of a high-frequency component of the interpolated image data. The adder 108 adds the interpolated image data and the high-frequency component calculated by the subtracter 107 together to generate the image data emphasizing the high-frequency component.

With the abovementioned configuration, two switches 109 are switched for each sub-frame, thereby outputting and displaying the high-frequency emphasized image data emphasizing the high-frequency component of the input image data (first sub-frame) and the low-frequency interpolated image data in which the high-frequency component of the interpolated image data has been suppressed (second sub-frame) at double-speed driving.

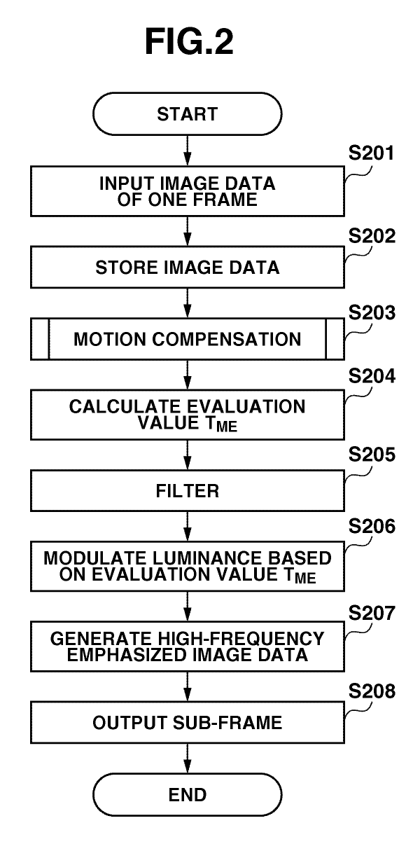

FIG. 2 is a flowchart illustrating processing according to the first exemplary embodiment. In step S201, image data of one frame is input to the frame memory 102 and the motion compensation unit 103. In step S202, the frame memory 102 stores input image data by one frame to output the image data to the motion compensation unit 103. The motion compensation unit 103 accordingly receives the input image data and image data of a last frame. In step S203, the motion compensation unit 103 generates interpolated image data based on the input image data and the image data of the last frame.

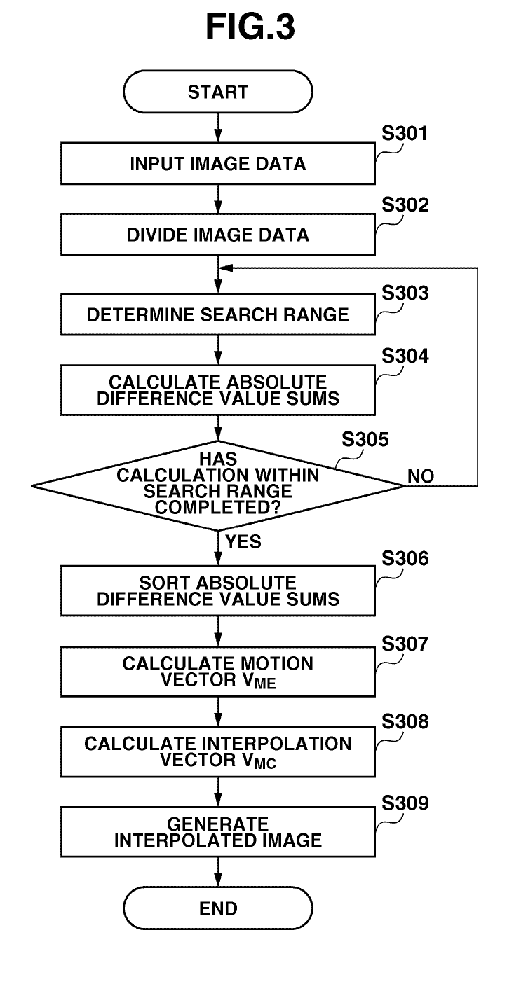

FIG. 3 is a flowchart illustrating generation of interpolated image data at the motion compensation unit 103 in detail. Instep S301, input image data and image data of a last frame are input to the motion compensation unit 103. In step S302, the motion compensation unit 103 divides the input image data into processing blocks. The processing blocks can be arbitrarily set. This step is not necessary when motion vectors are calculated on a pixel-by-pixel basis. In step S303, the motion compensation unit 103 sets a search range for detecting motion vectors. The search range can be arbitrarily set. For the search range, an entire frame can be set, or an arbitrary size larger than a processing target block can be set.

In step S304, the motion compensation unit 103 calculates absolute difference value sums between the processing target block and reference blocks within the search range set in step S303. In step S305, whether the motion compensation unit 103 has completed the calculation of the absolute difference value sums between the processing target block and the reference blocks within the set search range is determined. When it is determined that the calculation of the absolute difference value sums has not been completed (NO in step S305), steps S303 and S304 are repeated until the calculation of the absolute difference value sums between the processing target block and the reference blocks within the set search range is completed. When it is determined that the calculation of the absolute difference value sums has been completed for all the reference blocks within the search range (YES in step S305), the processing proceeds to step S306 to sort the calculated absolute value sums.

In step S307, the motion compensation unit 103 sets the reference block corresponding to a minimum value of the absolute difference value sums sorted in step S306 as a detected motion vector V_{ME}. In step S308, the motion compensation unit 103 calculates an interpolation vector V_{MC} from the motion vector V_{ME} calculated in step s307. An image temporally located in a center between the image data is generated as interpolated image data, and hence the interpolation vector V_{MC} is half of the motion vector V_{ME}. When the motion vector V_{ME} is calculated as V_{MC} or when the motion vector V_{ME} is large, interpolation vector V_{MC}=0 is set. When a reproduction environment is special reproduction such as fast-forwarding or rewinding, the interpolation vector V_{MC}=0 can be set.

In step S309, the motion compensation unit 103 generates interpolated image data from the interpolation vector V_{MC} calculated in step S308.

Thus, in the motion compensation of step S203 illustrated in FIG. 2, the motion compensation unit 103 generates the interpolated image data based on the input image data. The generation of the interpolated image data by the motion compensation unit 103 can be realized by using a conventional technology discussed in, for example, Japanese Patent Application Laid-Open No. 2009-042482 or Japanese Patent Application Laid-Open No. 2009-038620.

In step S204 illustrated in FIG. 2, the evaluation unit 104 calculates reliability of the motion vector V_{ME} detected by the motion compensation unit 103. By this calculation, the evaluation unit 104 estimates whether the motion vector V_{ME} has been correctly detected, and outputs a result of the estimation as an evaluation value T_{ME}.

There are three methods of calculating the evaluation value T_{ME}. The first method is to calculate the evaluation value T_{ME} by multiplying the minimum value of the absolute difference value sums calculated during the motion vector detection by a weight. According to the first method, the evaluation value becomes smaller as the minimum value of the absolute difference value sums corresponding to the detected motion vector becomes larger. More specifically, when processing target blocks at a start point and an end point of the motion vector detected within the search range are not similar, the evaluation value is set smaller because of a high possibility of erroneous detection of the motion vector.

The second method is to calculate the evaluation value T_{ME} by calculating a difference value between the minimum value of the absolute difference value sums and a second smallest value and multiplying the difference value by a weight. According to the second method, the evaluation value T_{ME} is smaller when there is a block similar to a block corresponding to the motion vector detected within the search range. More specifically, when the image includes similar patterns, the evaluation value T_{ME} is set smaller because of a high possibility of erroneous detection of the motion vector.

The third method is to calculate the evaluation value T_{ME} by multiplying a difference value between the motion vector V_{ME} and the interpolation vector V_{MC} by a weight. According to the third method, the evaluation value is smaller when the detected motion vector V_{ME} and the interpolation vector V_{MC} are different from each other in value. In the case of a block at an end of the image data, no motion vector may be detected. In such a case, the evaluation value is set smaller.

The three calculation methods have been described for the calculation of the evaluation value T_{ME} of step S204. The evaluation value T_{ME} can be calculated by using any one of the three methods or combining the methods. As a result, the evaluation value T_{ME} matching with characteristics of the motion compensation can be acquired. A value settable for the evaluation value T_{ME} can be selected from 0 and 1 or 0 to 255.

In step S205, when the switch 9 is connected to an output from the frame memory 102, the filter unit 105 performs low-pass filtering of the image data output from the frame memory 102. When the switch 9 is connected to an output from the motion compensation unit 103, the filter unit 105 performs low-pass filtering of the interpolated image data generated by the motion compensation unit 103. By the filtering, the filter unit 105 generates low-frequency image data in which a high-frequency component of the input image data is suppressed and a low-frequency interpolated image data in which a high-frequency component of the interpolated image data is suppressed.

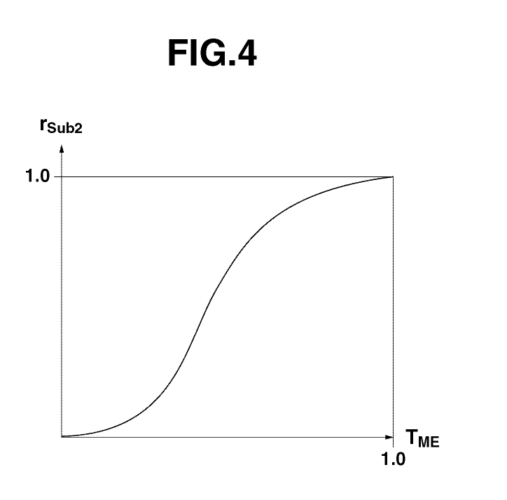

In step S206, the luminance control unit 106 calculates, based on the evaluation value T_{ME} output from the evaluation unit 104, output luminances r_{Sub2} of the low-frequency image data and the low-frequency interpolated image data output from the filter unit 105 to modulate the luminances. The luminance control unit 106 calculates the output luminance r_{Sub2} by using, for example, a monotonically increasing curve illustrated in FIG. 4.

When the curve illustrated in FIG. 4 is used, the output luminance r_{Sub2} becomes higher as the evaluation value T_{ME} becomes larger. Conversely, the output luminance r_{Sub2} becomes lower according to the curve as the evaluation value T_{ME} becomes smaller, increasing a luminance difference from the high-frequency emphasized image data. When the evaluation value T_{ME} is maximum (motion vector has been correctly detected), the output luminance r_{Sub2} of the low-frequency interpolated image data is equal to that of the high-frequency emphasized image data that becomes a first sub-frame, never exceeding the luminance of the high-frequency emphasized image data. More specifically, based on the evaluation value T_{ME}, the output luminance r_{Sub2} of the low-frequency interpolated image data is reduced relatively to the luminance of the high-frequency emphasized image data. Thus, a video failure caused by erroneous detection of the motion vector can be suppressed.

The luminance control unit 106 modulates the luminance of the low-frequency interpolated image data based on the calculated output luminance r_{Sub2} by the following expression (1):

L_{OUT}=L_{IN}×r_{Sub2} (1)

(L_{IN}: input luminance, L_{OUT}: output luminance)

Thus, the luminance control unit 106 outputs the low-frequency interpolated image data in which luminance has been modulated.

In step S207, when the switch 109 is connected to the output from the frame memory 102, the subtracter 107 calculates a difference between the input image data output from the frame memory 102 and the low-frequency image data output from the luminance control unit 106. The subtracter 107 accordingly calculates a high-frequency component of the input image data. The adder 108 adds together the calculated high-frequency component and the input image data. The adder 108 accordingly generates high-frequency emphasized image data. In step S207, when the switch 109 is connected to the output from the motion compensation unit 103, as in the abovementioned case, high-frequency emphasized image data is generated. However, a switch 110 does not output this high-frequency emphasized image data.

In step S208, the switch 110 alternately outputs, by switching outputs in conjunction with the switch 109, the high-frequency emphasized image data (first sub-frame) and the low-frequency interpolated image data (second sub-frame) at a double frequency of an input frequency.

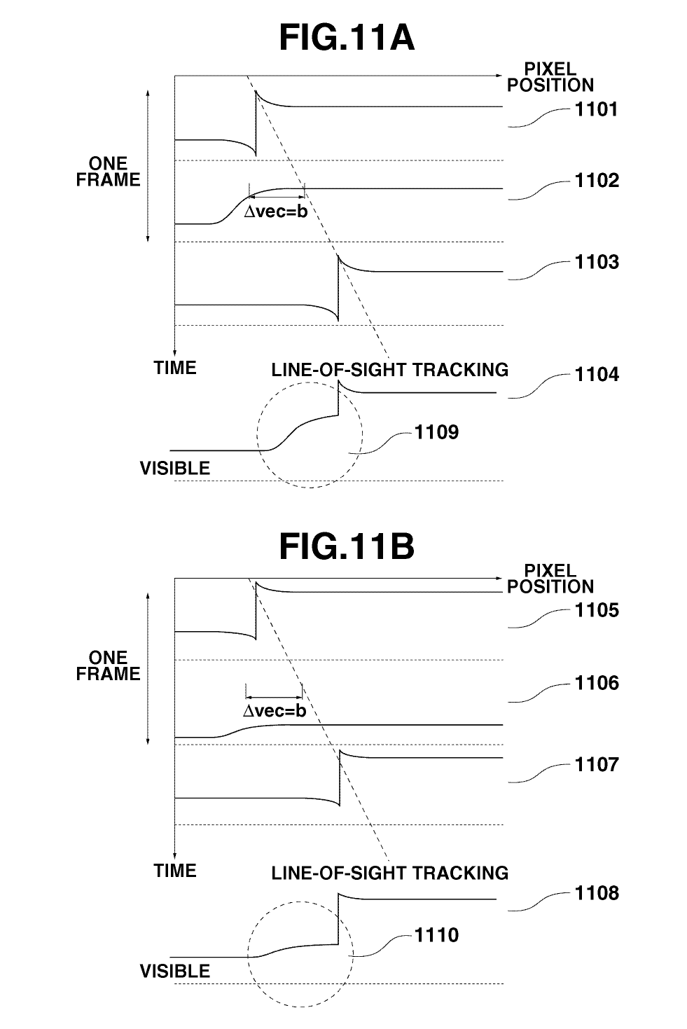

FIGS. 11A and 11B illustrate high-frequency emphasized image data (1101, 1103, 1105, and 1107) and low-frequency interpolated image data (1102 and 1106) output when the motion vector T_{ME} detected by the motion compensation unit 103 deviates from a motion vector to be correctly detected by b pixels FIGS. 11A and 11B also illustrate actual visible images (1104 and 1108). FIG. 11A illustrates an output when the luminance control unit 106 performs no luminance control. In this case, a portion 1109 of the visible image 1104 is visible as a motion blur. FIG. 11B illustrates an output when the luminance control unit 106 performs luminance control according to the first exemplary embodiment. In FIG. 11B, when the motion vector deviates, the evaluation value T_{ME} is reduced, and luminance of the low-frequency interpolated image data 1106 is lowered. As a result, an output value of a portion 1110 visible as a failure or a motion blur is reduced.

According to the first exemplary embodiment, when reliability of detection of a motion vector by the motion compensation unit 103 is low (possibility of erroneous detection is high), the image is displayed by setting a luminance difference between the first sub-frame and the second a sub-frame. As a result, video failures can be reduced.

According to a second exemplary embodiment, when reliability of detection of a motion vector is low, an image is displayed by setting a luminance difference between a first sub-frame and a second sub-frame. When visibility of a failure is estimated to be high, a luminance difference is set between the first sub-frame and the second sub-frame.

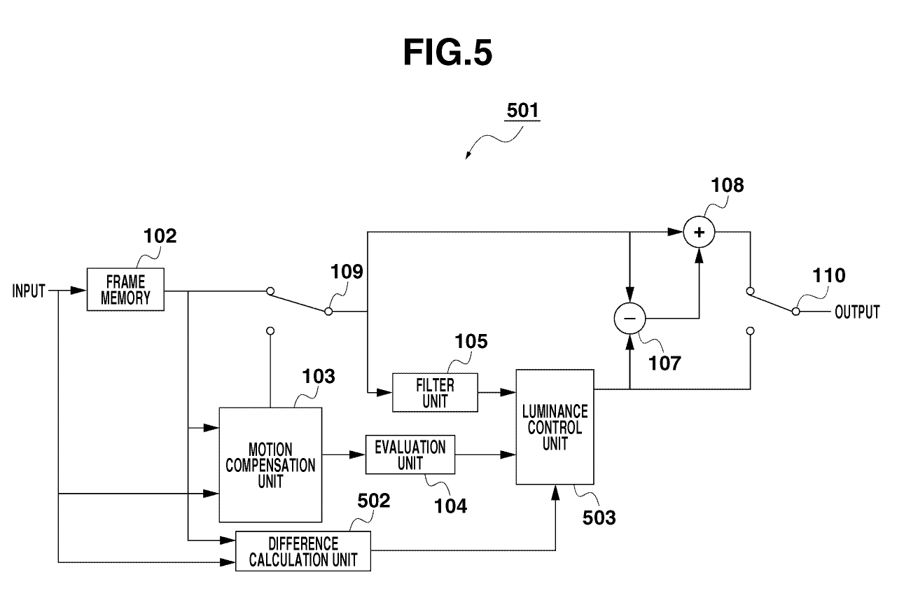

FIG. 5 is a block diagram illustrating a configuration of a main portion of an image processing apparatus 501 according to the second exemplary embodiment. Portions of the image processing apparatus similar to those of the first exemplary embodiment will not be described. A characteristic configuration of the second exemplary embodiment will be described.

A difference calculation unit 502 calculates a luminance difference D between input image data and past image data stored in a frame memory 102 (in the second exemplary embodiment, image data of a last frame of the input image data), and outputs the luminance difference D to a luminance control unit 503. The luminance control unit 503 controls, based on an evaluation value T_{ME} output from an evaluation unit 104 and the luminance difference D output from the difference calculation unit 502, luminance of low-frequency image data in which a high-frequency component has been suppressed by a filter unit 105.

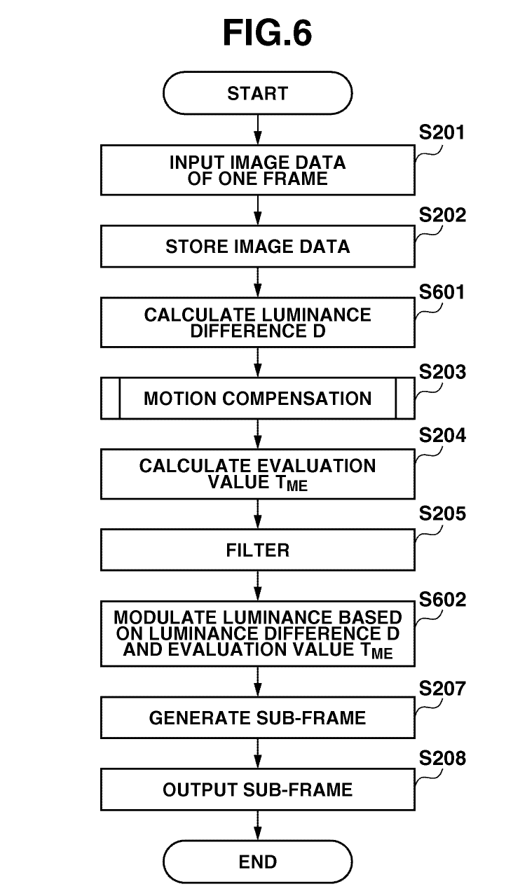

FIG. 6 is a flowchart illustrating processing in the second exemplary embodiment. Processing similar to that of the first exemplary embodiment will not be described. In step S601, the difference calculation unit 501 calculates the luminance difference D between the input image data and the past image data stored in the frame memory 102. The luminance difference D is a difference between a target block of the input image data and a block of the past image data corresponding to the target block.

In step S602, the luminance control unit 503 calculates, based on the evaluation value T_{ME} output from the evaluation unit 104 and the luminance difference D output from the difference calculation unit 502, output luminance r_{Sub2} of the low frequency image data output from the filter unit 105, and modulates the luminance of the low-frequency image data.

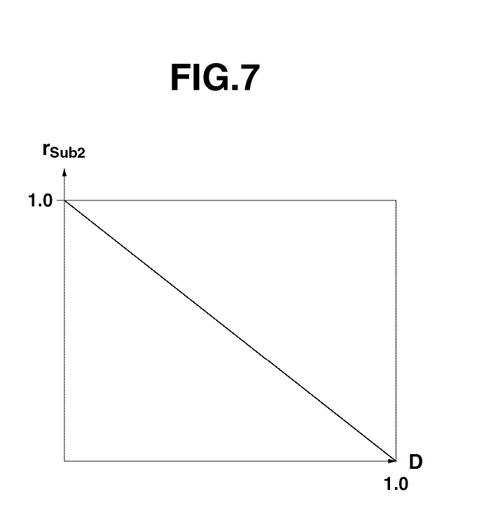

For the output luminance r_{Sub2} of the low-frequency image data, as in the case of the first exemplary embodiment, the luminance control unit 503 calculates output luminance r_{Sub2} (T_{ME}) so that the output luminance r_{Sub2} becomes higher as the evaluation value T_{ME} becomes larger by using the curve illustrated in FIG. 4. The luminance control unit 503 calculates output luminance r_{Sub2} (D) so that the output luminance r_{Sub2} becomes higher as the luminance difference D becomes smaller by using a monotonic decrease function illustrated in FIG. 7. Lastly, the luminance control unit 503 calculates output luminance r_{Sub2} based on a product of the output luminance r_{Sub2} (T_{ME}) and the output luminance r_{Sub2} (D). A reason for increasing the output luminance r_{Sub2} as the luminance difference D is smaller is that a motion blur caused by erroneous detection of a motion vector is difficult to be visible when a luminance difference between frames is small. Thus, even if an evaluation value of the motion vector is small, when the luminance difference between the frames is small, the motion blur is difficult to be visible. As a result, the motion blur is difficult to be visible even when the luminance difference between the frames is small.

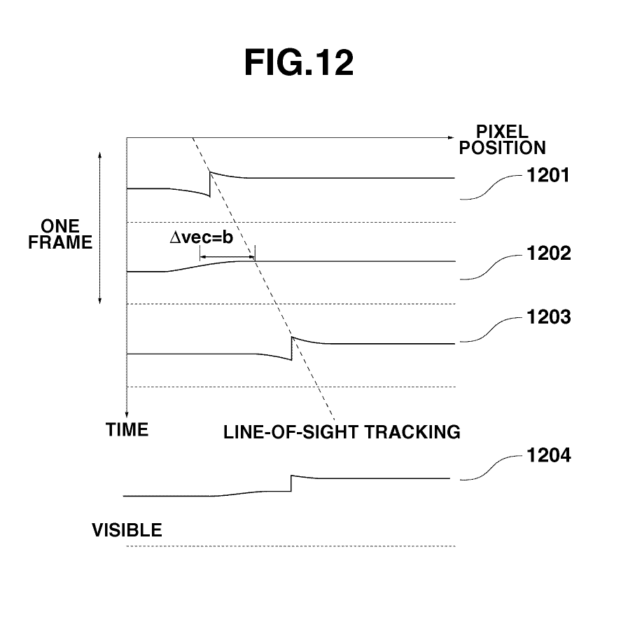

FIG. 12 illustrates high-frequency emphasized image data (1201 and 1203) and low-frequency interpolated image data (1102) output when a motion vector V_{ME} deviates from a motion vector to be correctly detected by b pixels, and an actual visible image (1204) in the second exemplary embodiment. The image data illustrated in FIG. 12 has edge contrast lower than that of the image data illustrated in FIGS. 11A and 11B. Even when the motion vector V_{ME} detected by a motion compensation unit 103 deviates from the motion vector to be correctly detected by b pixels, a luminance difference D is small because of the low edge contrast. As a result, the low-frequency data is output without lowering its luminance. In the case of the actual visible image 1204, any failures caused by erroneous detection of a motion vector is difficult to be visible because of the low edge contrast.

Thus, even when reliability of detection of a motion vector by the motion compensation unit 103 is low (possibility of erroneous detection is high), if a luminance difference between frames is small, excessive luminance control of a first sub-frame and a second sub-frame can be suppressed.

The second exemplary embodiment has been directed to the configuration where the luminance control unit 503 calculates the output luminance r_{Sub2} by using the evaluation value T_{ME} output from the evaluation unit 104 and the luminance difference D output from the difference calculation unit 502. The present modified example is directed to a configuration where a luminance control unit 503 calculates output luminance r_{Sub2} by using not only an evaluation value T_{ME} but also a detected motion vector V_{ME} and luminance L_{IN} of an input frame.

In this case, as in the case of the first exemplary embodiment, the luminance control unit 503 calculates output luminance r_{Sub2} (T_{ME}) so that the output luminance r_{Sub2} becomes higher as the evaluation value T_{ME} becomes larger by using the curve illustrated in FIG. 4. The luminance control unit 503 calculates output luminance r_{Sub2} (V_{ME}) so that the output luminance r_{Sub2} becomes higher as the detected motion vector V_{ME} becomes smaller by using the monotonic decrease function illustrated in FIG. 7. As in the case of the output luminance r_{Sub2} (V_{ME}), the luminance control unit 503 calculates output luminance r_{Sub2} (L_{IN}) so that the output luminance r_{Sub2} becomes higher as the luminance L_{IN} of the input frame becomes lower by using the monotonic decrease function illustrated in FIG. 7. Lastly, the luminance control unit 503 calculates output luminance r_{Sub2} based on a product of the output luminance r_{Sub2} (T_{ME}), the output luminance r_{Sub2} (V_{ME}), and the output luminance r_{Sub2} (L_{IN}).

Thus, the present modified example can provide the same effects as those of the second exemplary embodiment.

In the first exemplary embodiment and the second exemplary embodiment, the motion compensation unit 103 generates the interpolated frame based on the input image data and the past image data stored in the frame memory 102. The filter unit 105 generates the low-frequency image data by suppressing the high-frequency component of the generated interpolated image data, and outputs the low-frequency image data to the luminance control unit 106. According to a third exemplary embodiment, however, a filter unit generates a second sub-frame based on low-frequency image data in which a high-frequency component of input image data has been suppressed, and low-frequency image data of past image data, and outputs the second sub-frame to a luminance control unit 106.

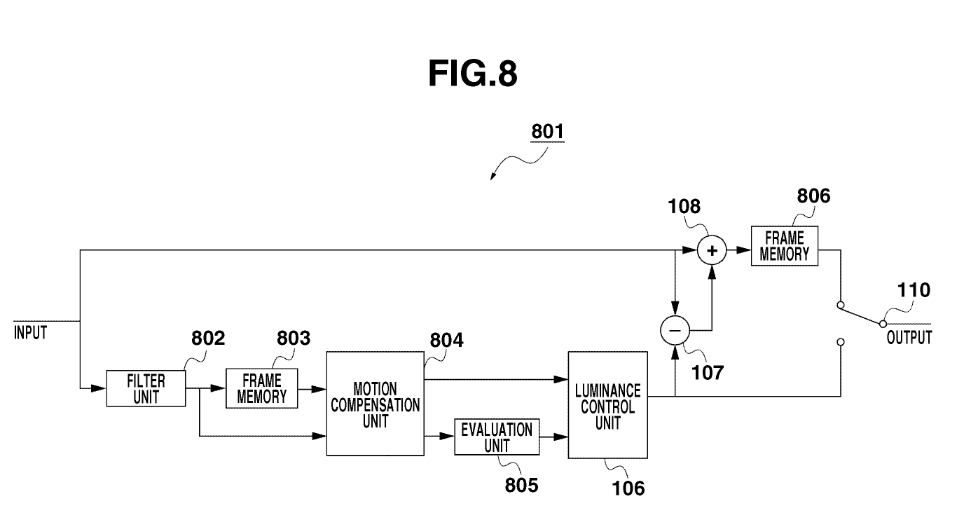

FIG. 8 is a flowchart illustrating a configuration of a main portion of an image processing apparatus 801 according to the third exemplary embodiment. Portions of the image processing apparatus similar to those of the first exemplary embodiment will not be described. A characteristic configuration of the third exemplary embodiment will be described.

A filter unit 802 suppresses a high-frequency component of input image data to generate low-frequency image data. A frame memory 803 stores the low-frequency image data by at least one frame. A motion compensation unit 804 detects a motion vector based on the low-frequency image data generated by the filter unit 802 and low-frequency image data of past image data stored in the frame memory 802. The motion compensation unit 804 performs motion compensation to generate low-frequency interpolated image data in which motion between image data has temporally been interpolated. An evaluation unit 805 estimates reliability of the motion vector detected by the motion compensation unit 804 to output an evaluation value to the luminance control unit 106. A calculation method of the evaluation value is similar to that of the first exemplary embodiment.

The luminance control unit 106 controls luminance of the low-frequency interpolated image data generated by the motion compensation unit 804 based on the evaluation value output from the evaluation unit 805. A subtracter 107 and an adder 108 generate high-frequency emphasized image data emphasizing a high-frequency component. A frame memory 806 stores and outputs the high-frequency emphasized image data generated by the subtracter 107 and the adder 108 by at least one frame.

With this configuration, the high-frequency emphasized image data and the low frequency interpolated image data are output to be displayed at double-speed driving by switching a switch 110 for each sub-frame.

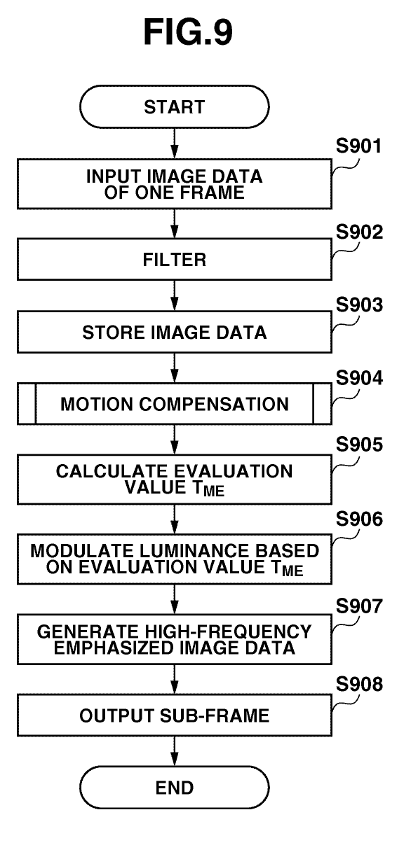

FIG. 9 is a flowchart illustrating processing according to the third exemplary embodiment. In step S901, the filter unit 802 receives image data of one frame. Instep S902, the filter unit 802 performs low-pass filtering of the input image data to generate low-frequency image data. Instep S903, the frame memory 803 stores, by one frame, the low-frequency image data filtered by the filter unit 802, and outputs the low-frequency image data to the motion compensation unit 804. In step S904, the motion compensation unit 804 generates low-frequency interpolated image data based on the input low-frequency image data and past low-frequency image data stored in the frame memory 803. The motion compensation unit 804 and the motion compensation unit 103 of the first exemplary embodiment are similar in processing while input image data are different (unfiltered image data and filtered image data). More specifically, the motion compensation unit 804 detects a motion vector between the low-frequency image data, and performs motion compensation to generate low-frequency interpolated image data.

In step S905, the evaluation unit 805 calculates reliability of the motion vector detected by the motion compensation unit 804. In step S906, the luminance control unit 106 calculates, based on an evaluation value T_{ME} output from the evaluation unit 805, output luminance r_{Sub2} of the low-frequency interpolated image data generated by the motion compensation unit 804 to modulate luminance of the low-frequency interpolated image data. In step S907, a subtracter 107 and an adder 108 generate high-frequency emphasized image data. In step S908, a switch 110 alternately outputs the high-frequency emphasized image data and the low-frequency interpolated image data at a double frequency of an input frequency.

With this configuration, the third exemplary embodiment can provide the same effects as those of the first exemplary embodiment.

The exemplary embodiments have been described based on the assumption that the units of the apparatus illustrated in FIGS. 1, 5, and 8 are all hardware units. However, the units other than the frame memories illustrated in FIGS. 1, 5, and 8 can be configured by computer programs. In this case, a computer including a memory for storing the computer program and a central processing unit (CPU) for executing the computer program stored in the memory can be applied to the image processing apparatus of each of the exemplary embodiments.

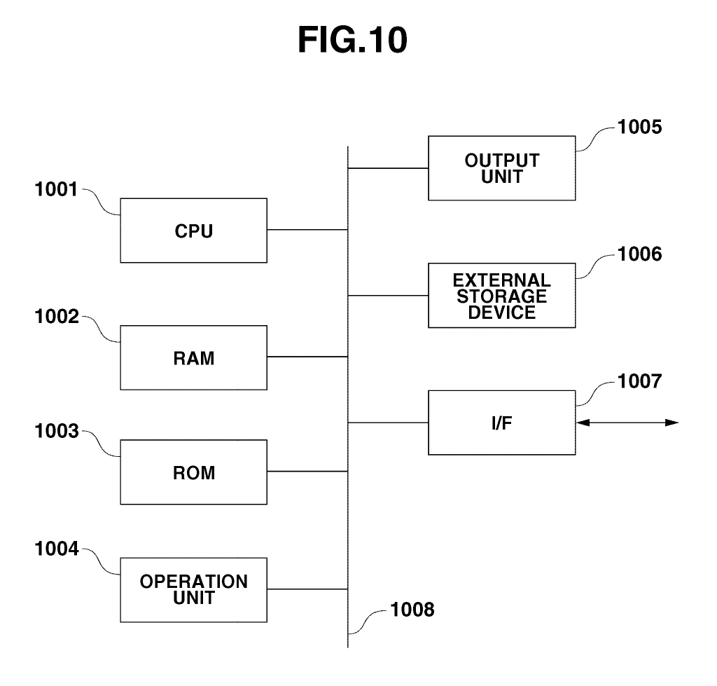

FIG. 10 is a block diagram illustrating a hardware configuration example of the computer applicable to the image processing apparatus of each of the exemplary embodiments.

A CPU 1001 controls the computer overall by using a computer program or data stored in a random access memory (RAM) 1002 or a read-only memory (ROM) 1003, and executes each processing described above as performed in the image processing apparatus of each exemplary embodiment. More specifically, the CPU 1001 functions as the units 103 to 110 illustrated in FIG. 1, or the units 502 and 503 illustrated in FIG. 5.

The RAM 1002 has an area for temporarily storing a computer program or data loaded from an external storage device 1006 or data acquired from the outside via an interface (I/F) 1009. The RAM 1002 has an area used when the CPU 1001 executes various processes. More specifically, for example, the RAM 1002 can be appropriated for a frame memory, or can appropriately provide various other areas.

The ROM 1003 stores setting data of the computer or a boot program. An operation unit 1004 includes a keyboard or a mouse. A user of the computer can input various instructions to the CPU 1001 by operating the operation unit 1004. An output unit 1005 displays a processing result of the CPU 1001.

The external storage device 1006 is a large capacity information storage device represented by a hard disk drive. The external storage device 1006 stores an operating system (OS) or a computer program for causing the CPU 1001 to realize flows illustrated in FIGS. 2, 3, and 6. The external storage device 1006 may store image data that is a processing target.

The computer program or the data stored in the external storage device 1006 is appropriately loaded to the RAM 1002 under control of the CPU 1001 as a processing target of the CPU 1001.

A network such as a local area network (LAN) or Internet, and other devices can be connected to the I/F 1007. The computer can acquire or transmit various pieces of information via the I/F 1007. A bus 1008 interconnects the units.

In the abovementioned configuration, the CPU 1001 plays a central role in performing the operations of the flowcharts.

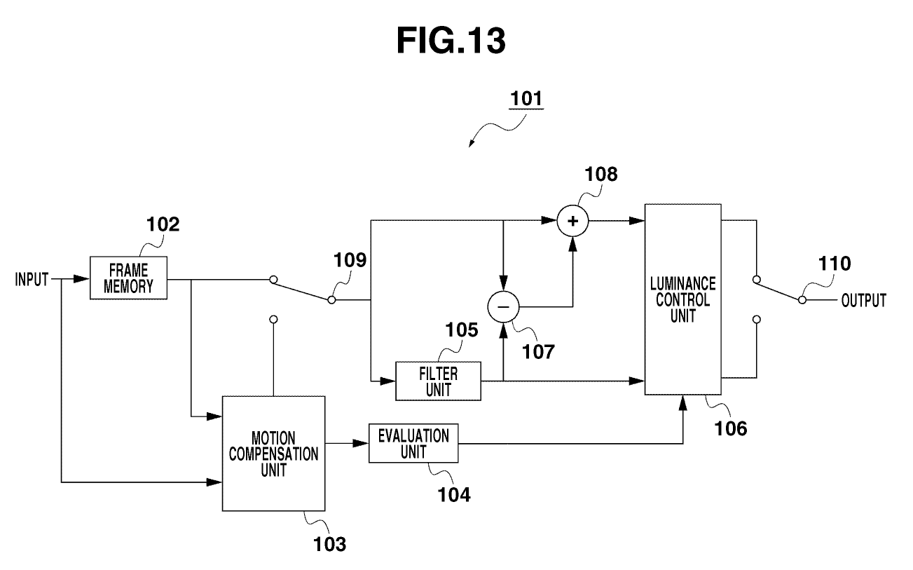

In the configuration up to generation of the sub-frames in the first to fourth exemplary embodiments, with respect to the low-frequency interpolated image data output from the luminance control unit 106, the high-frequency emphasized image data is generated by using the subtracter 107 and the adder 108. However, as illustrated in FIG. 13, a luminance correction unit may be disposed before a switch 110 to set luminances of high-frequency emphasized image data and low-frequency interpolated image data. According to the present invention, video failures can be reduced by controlling the luminance of the low-frequency interpolated image data to be relatively lower than that of the high-frequency emphasized image data, thereby generating a luminance difference between the sub-frames. Thus, in the configuration illustrated in FIG. 13, a luminance control unit 106 can perform control to increase the luminance of the high-frequency emphasized image data based on an evaluation value T_{ME}. This control enables generation of a luminance difference between the sub-frames.

The same effects can be provided when a high-pass filter is used for filtering by a filter unit 105 to generate high-frequency emphasized image data and low-frequency interpolated image data.

Each of the first to fourth exemplary embodiments has been directed to the configuration where the sub-frame is output and displayed at a double speed of the input frame rate. However, the sub-frame can be output at an N-fold-speed (N>2). This arrangement can be realized by changing the number of interpolation frames generated by the motion compensation units 103 and 804 from 1 to N. In this case, motion blurs can be reduced more.

The first to fourth exemplary embodiments have been described based on the assumption that the luminance control of the luminance control unit 106 is pixel unit control within one frame. However, by using an average value or a median of the evaluation value T_{ME}, the motion vector V_{ME}, the input luminance L_{IN}, and the luminance value D as a representative value, luminance r_{Sub2} can be set on a frame-by-frame basis. In this case, by setting a change amount of the set luminance per unit time equal to or less than a preset threshold value, image quality deterioration unique to a processing boundary can be suppressed spatially and temporally.

The exemplary embodiments of the present invention have been described. A control method of the apparatus of the present invention is also within the invention. The present invention can be applied to a system including a plurality of devices, or an apparatus including one device.

The present invention can be achieved by supplying a program for realizing each function of the exemplary embodiments to a system or an apparatus directly or from a remote place, and reading and executing a supplied program code by a computer included in the system or the apparatus.

Thus, the program code itself installed into the computer to realize the function/processing of the present invention by the computer realizes the invention. More specifically, the computer program itself for realizing the function/processing is within the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-219221 filed Sep. 24, 2009, which is hereby incorporated by reference herein in its entirety.

What is claimed is:

1. An apparatus for generating high-frequency emphasized image data emphasizing a high-frequency component and low-frequency interpolated image data using motion compensation, from image data input for each frame, and outputting the high-frequency emphasized image data and the low-frequency interpolated image data as sub-frames, comprising:
a calculation unit configured to calculate an evaluation value of a motion vector detected during the motion compensation; and
a control unit configured to control, based on the calculated evaluation value, luminance of the low-frequency interpolated image data to be lowered relative to the high-frequency emphasized image data.

2. The apparatus according to claim 1, wherein the calculation unit calculates the evaluation value based on a minimum value of absolute difference value sums between a detection target block of the motion vector and reference destination blocks of motion vectors.

3. The apparatus according to claim 1, wherein the control unit increases a luminance difference between the low-frequency interpolated image data and the high-frequency emphasized image data more as the calculated evaluation value becomes smaller.

4. The apparatus according to claim 1, further comprising a difference calculation unit configured to calculate a luminance difference between frames of the image data input for each frame,
wherein the control unit controls, based on the calculated evaluation value and the calculated luminance difference, the luminance of the low-frequency interpolated image data, to be lowered relative to the high-frequency emphasized image data.

5. An apparatus comprising:
an input unit configured to input image data of m frames per unit time;
a filter unit configured to generate at least high-frequency emphasized image data from the input image data;
an interframe interpolation unit configured to generate low-frequency interpolated image data subjected to motion compensation and temporally located halfway between the input image data and image data input at a previous frame;
a calculation unit configured to calculate an evaluation value of a motion vector detected during the motion compensation;
a control unit configured to control, based on the calculated evaluation value, luminance of the low-frequency interpolated image data, to be lowered relative to the high-frequency emphasized image data; and
an output unit configured to alternately output the high-frequency emphasized image data and the low-frequency interpolated image data with the luminance, as image data of 2m frames per unit time.

6. A method of controlling an apparatus that generates high-frequency emphasized image data emphasizing a high-frequency component and low-frequency interpolated image data using motion compensation, from image data input for each frame, and outputs the high-frequency emphasized image data and the low-frequency interpolated image data as sub-frames, comprising:
calculating an evaluation value of a motion vector detected during the motion compensation; and
controlling, based on the calculated evaluation value, luminance of the low-frequency interpolated image data, to be lowered relative to the high-frequency emphasized image data.

7. The method according to claim 6, wherein the calculating calculates the evaluation value based on a minimum value of absolute difference value sums between a detection target block of the motion vector and reference destination blocks of motion vectors.

8. The method according to claim 6, further comprising increasing a luminance difference between the low-frequency interpolated image data and the high-frequency emphasized image data more as the calculated evaluation value becomes smaller.

9. The method according to claim 6, further comprising:
calculating a luminance difference between frames of the image data input for each frame; and
controlling the luminance of the low-frequency interpolated image data to be lowered relative to the high-frequency emphasized image data based on the calculated evaluation value and the calculated luminance difference.

10. A method of controlling an apparatus, comprising:
inputting image data of m frames per unit time;
generating at least high-frequency emphasized image data from the input image data;
generating low-frequency interpolated image data subjected to motion compensation and temporally located halfway between the input image data and image data input at a previous frame;
calculating an evaluation value of a motion vector detected during the motion compensation;
controlling, based on the calculated evaluation value, luminance of the low-frequency interpolated image data, to be lowered relative to the high-frequency emphasized image data; and
alternately outputting the high-frequency emphasized image data and the low-frequency interpolated image data with luminance controlled, as image data of 2m frames per unit time.

11. A computer readable storage medium storing a computer-executable program of instructions for causing a computer to perform the method according to of claim 6.

12. The computer readable storage medium according to claim 11, wherein the calculating calculates the evaluation value based on a minimum value of absolute difference value sums between a detection target block of the motion vector and reference destination blocks of motion vectors.

13. The computer readable storage medium according to claim 11, further comprising increasing a luminance difference between the low-frequency interpolated image data and the high-frequency emphasized image data more as the calculated evaluation value becomes smaller.

14. The computer readable storage medium according to claim 11, further comprising:
calculating a luminance difference between frames of the image data input for each frame; and
controlling the luminance of the low-frequency interpolated image data to be lowered relative to the high-frequency emphasized image data based on the calculated evaluation value and the calculated luminance difference.
